(19) United States
(12) Patent Application Publication
(10) Pub. No.: US 2025/0146623 A1
(43) Pub. Date: May 8, 2025

(54) MOBILE GAS STORAGE SYSTEM

(71) Applicant: VOLTAGRID LLC, BELLAIRE, TX (US)

(72) Inventors: Jackson Lin, Calgary (CA); Leslie Michael Wise, Houston, TX (US); Nathan Ough, Bellaire, TX (US); Tejinder Singh Gill, Calgary (CA)

(73) Assignee: VOLTAGRID LLC, BELLAIRE, TX (US)

(21) Appl. No.: 18/935,797

(22) Filed: Nov. 4, 2024

Related U.S. Application Data
(60) Provisional application No. 63/597,148, filed on Nov. 8, 2023.

(51) Int. Cl. F17C 7/00

(52) U.S. Cl. CPC F17C 7/00; F17C 2205/013; F17C 2221/033; F17C 2227/0157; F17C 2250/03; F17C 2250/0491; F17C 2270/0171

(57) ABSTRACT

A mobile gas storage system can include a trailer skid, one or more gas tanks, and a compressor. At least one of the one or more gas tanks or the compressor are coupled to the trailer skid. The compressor is configured to compress gas from a gas source into the one or more gas tanks. The one or more gas tanks are configured to provide gas to a downstream device.

### TECHNICAL FIELD

The present disclosure relates generally to gas storage, and more particularly, to gas compression, storage, and deployment and methods of operation thereof.

### BACKGROUND

Natural gas is often a byproduct of oil production. Oil is found in hydrocarbon reservoirs such as coal beds, trapped by salt domes, or in other underground rock formations and structural traps. The natural gas produced along with the oil (known as field gas) is often flared off or sold, but can also be captured and used as a fuel source.

In some applications, it is desired to use field gas directly as a fuel source. For example, in some applications, it may be desired to use field gas as a fuel source for generators, heaters, pumps, and/or other devices that require significant gas flow. However, in some applications, field gas flow is unstable, unreliable, or otherwise insufficient to meet the demand of downstream devices. Similarly, in some applications, gas flow from a utility provider may require significant infrastructure and may be unreliable, unavailable, or insufficient to meet demand of downstream devices.

Therefore, in certain conventional applications, providing sufficient, stable, and reliable gas flow to downstream devices can be challenging. Providing sufficient and reliable gas flow to a site may require significant resources, infrastructure, and/or transportation (e.g., trailers of fuel). Further, certain conventional applications may not be able to meet the demands of desired downstream uses. Therefore, certain conventional gas delivery systems can be uneconomical, time-consuming, and/or impractical to use.

Therefore, what is needed is an apparatus, system or method that addresses one or more of the foregoing issues, among one or more other issues.

### SUMMARY

In one embodiment, a mobile gas storage system can include a trailer skid, one or more gas tanks, and a compressor. The gas tanks or the compressor can be coupled to the trailer skid. Further, the compressor can be configured to compress gas from a gas source into the one or more gas tanks. The one or more gas tanks can be configured to provide gas to a downstream device.

In another embodiment, a method to provide gas is disclosed. The method can include slipstreaming gas from a gas source when a gas supply of the gas source exceeds a gas demand of a downstream device. The method can further include compressing gas from the gas source into one or more storage tanks coupled to a trailer skid. Further, the method can include providing gas from the one or more storage tanks to the downstream device when the gas demand of the downstream device exceeds the gas supply of the gas source.

In another embodiment, a non-transitory machine readable storage medium can contain executable instructions which, when executed by a controller, cause the controller to perform a method. The method can include activating a compressor to compress gas slipstreamed from a gas source into one or more gas tanks when a gas supply exceeds a gas demand of a downstream device. Further, the method can include providing gas to the downstream device via the one or more gas tanks when the gas demand of the downstream device exceeds the gas supply of the gas source.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a schematic diagram of a gas processing and distribution system in accordance with embodiments of the present disclosure.

FIG. 2 is a schematic diagram of a gas storage system in accordance with embodiments of the present disclosure.

FIG. 3 is a schematic diagram of a gas storage system in accordance with embodiments of the present disclosure.

FIG. 4 is a side elevation view of the gas storage system of FIGS. 2 and 3.

### DETAILED DESCRIPTION

The present disclosure relates generally to gas storage systems, and more particularly, to a mobile gas storage system and methods of operation thereof. As described herein, embodiments of the gas storage system and methods of use thereof address the issues described with respect to traditional gas delivery configurations.

Certain conventional gas delivery systems may be unstable, unreliable, or provide insufficient gas flow to meet demand of downstream devices. Certain conventional gas delivery systems may require significant resources, infrastructure, and/or transportation to provide a desired throughput. As a result, certain conventional gas delivery systems can be uneconomical, time-consuming, impractical to use, or may reduce performance of downstream devices (e.g., generators).

As described herein, embodiments of the gas storage system can include a compressor and one or more gas tanks mounted on a trailer to allow excess gas supply to be compressed into the gas tanks and deployed to downstream devices when demand exceeds the gas flow from the gas supply. Advantageously, embodiments of the gas storage system can allow for the automatic capture and deployment of excess gas supply, avoiding flaring of excess gas and allowing for full performance of downstream devices without requiring the infrastructure or transportation of conventional gas delivery systems. Further embodiments of the gas storage system include design features to allow for flexible operation, layout, and ease of transport, permitting the gas storage system to be utilized on site. Certain embodiments of the gas storage system can be tailored to the characteristics of the gas supply and/or the demands of the gas-powered downstream devices.

The gas storage system uses a compressor and one or more tanks to deploy gas to downstream devices. The exemplary gas storage system embodiments shown in the drawings are not limiting. Each embodiment may include components shown in the drawings and may include other components not shown in the drawings as necessary based on the parameters of the gas supply and/or to meet the demands of the downstream devices.

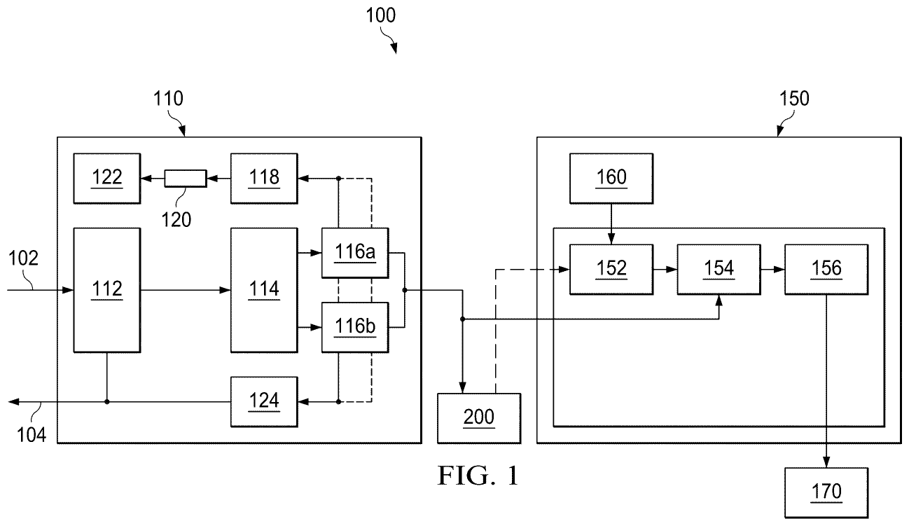

FIG. 1 is a schematic diagram of a gas processing and distribution system 100 in accordance with embodiments of the present disclosure. With reference to FIG. 1, the gas processing and distribution system 100 can provide fuel to one or more downstream devices 170. As described herein, a gas storage system 200 can be used with the gas processing and distribution system 100 to allow for desired fuel flow when fuel demand from the downstream devices 170 outstrips the fuel supply from the gas processing and distribution system 100.

In some embodiments, the gas processing and distribution system 100 includes a gas processing system 110 to process gas. As illustrated, the gas processing system 110 can process inlet gas 102 to remove excess water, sulfides, and/or other components. In some embodiments, the inlet gas 102 is field gas produced during the production of other hydrocarbons. Optionally, the inlet gas 102 can be gas provided by a utility provider or via transport. In some embodiments, the gas processing and distribution system 100 may omit the gas processing system 110 and may direct field or utility gas to the gas distribution system 150 or to a downstream device 170 without processing. Further, in some embodiments, field or utility gas may bypass the gas processing system 110 and may be directed to the gas distribution system 150 or to a downstream device 170 without processing.

In some embodiments, bulk liquid is removed from the inlet gas 102 via a slug catcher 112. If required, hydrogen sulfide is removed from the gas via a hydrogen sulfide regulating device 114. Further, in some applications, heavy hydrocarbons can be removed from the inlet gas 102 by mobile refrigeration units 116a, 116b. In certain applications, the mobile refrigeration units 116a, 116b can include certain features described in pending U.S. application Ser. No. 17/679,776 filed Feb. 24, 2022, and titled “Mobile Refrigeration Unit.” Removed heavy hydrocarbons can be removed from the gas processing system 110 via outlet 104. In some embodiments, natural gas liquids can be stored in storage tank 124.

As illustrated, processed gas from the gas processing system 110 can be provided to the gas distribution system 150. Optionally, excess gas can be flared. Gas to be flared can be accumulated in a flare knock out drum 118 and flared via flare stack 122. A flame arrestor 120 can be disposed between the flare stack 122 and the flare knock out drum 118. In certain applications, the gas processing system can include certain features described in pending U.S. application Ser. No. 18/055,503 filed Nov. 15, 2022, and titled “Modular Gas Processing System.”

In the depicted example, gas provided to the gas distribution system 150 can be distributed to one or more downstream devices 170. In some embodiments, the gas processing and distribution system 100 may omit the gas distribution system 150 and may direct field or utility gas to a downstream device 170 without additional distribution. Further, in some embodiments, field or utility gas may bypass the gas distribution system 150 and may be directed to a downstream device 170 without passing through the gas distribution system 150.

As illustrated, gas entering the gas distribution system 150 can be pressure regulated by a low-pressure distribution device 154. Optionally, high pressure gas entering the gas distribution system 150 can be pressure regulated by a high-pressure distribution device 152, which in turn passes through the low-pressure distribution device 154. In some embodiments, high pressure natural gas transported via trailers 160 can be introduced into the gas distribution system 150 via the high-pressure distribution device 152. The gas from the gas distribution system 150 can be distributed to one or more downstream devices 170 via a hose reel 156. The hose reel 156 can contain a plurality of hose reels with flexible hoses to direct output gas to downstream devices in various locations and/or different configurations. In certain applications, the gas distribution system can include certain features described in pending U.S. application Ser. No. 18/055,503 filed Nov. 15, 2022, and titled “Modular Gas Processing System.”

As illustrated, gas from the gas processing and distribution system 100 is provided to one or more downstream devices 170. In some embodiments, the downstream device 170 can be any suitable device, including, but not limited to, generators, heaters, pumps, and/or other devices that require gas flow for operation. In some embodiments, the downstream device 170 can be one or more reciprocating generators. In some applications, the downstream device 170 can be one or more reciprocating generators operatively connected via a switchgear to a common load and can include certain features described in pending U.S. application Ser. No. 17/385,441, filed Jul. 26, 2021, titled “Common Bus Switchgear for Mobile Hybrid Micro-grids,” U.S. application Ser. No. 17/575,194, filed Jan. 13, 2022, titled “Mobile Hybrid Microgrids,” and U.S. application Ser. No. 17/748,543, filed May 19, 2022, titled “Coordinated Generation, Transmission, and Utilization of Electric Power Among Geographically Remote Locations.”

In some applications and during certain periods, the gas processing and distribution system 100 may have excess gas supply or capacity while during other periods the system may not be able to provide sufficient gas flow to meet the demands of the downstream devices 170. In the depicted example, the gas storage system 200 can store excess gas and provide gas to downstream devices 170 if demand exceeds supply. Advantageously, the gas storage system 200 can provide gas to the downstream devices 170 if gas flow is unavailable, interrupted, unreliable, or otherwise insufficient to meet demand. In some embodiments, multiple gas storage systems 200 can be utilized to provide a desired storage or supply capacity.

In the depicted example, the gas storage system 200 can receive gas from any suitable source. As illustrated, the gas storage system 200 can receive and store processed gas from the gas processing system 110. Advantageously, the gas stored within the gas storage system 200 can be conditioned or processed to be suitable for the downstream devices 170. In some embodiments, the gas storage system 200 can receive and store gas direct from a utility provider, field gas, mobile tankers, or any other suitable source. In some applications, the gas storage system 200 can receive or slipstream gas when the gas processing and distribution system 100 can provide excess gas supply or capacity after meeting the demand of the downstream devices 170. As discussed herein, the stored gas can be compressed in tanks of the gas storage system 200.

During operation, if demand of the downstream devices 170 exceeds the capacity of the gas processing and distribution system 100 (e.g., if one or more generators is required to generate increased electrical output), the gas storage system 200 can deploy stored gas to meet demand of the downstream devices 170. As illustrated, compressed stored gas can be deployed into the high-pressure distribution device 152 of the gas distribution system 150 and ultimately to the downstream devices 170.

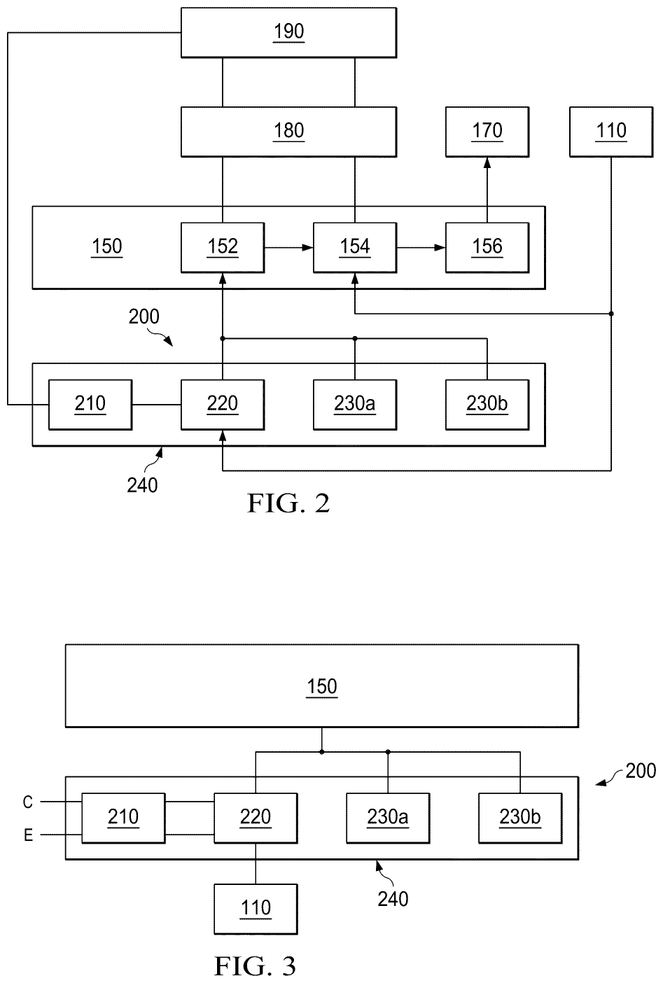

FIGS. 2 and 3 are schematic diagrams of a gas storage system 200 in accordance with embodiments of the present disclosure. In the depicted example, the gas storage system 200 utilizes a compressor 220 to compress gas from the gas processing system 110 or any other suitable fuel source to store within one or more tanks 230a, 230b. The compressed fuel within the tanks 230a, 230b may be deployed if demand of the one or more downstream devices 170 exceeds the capacity of the gas processing and distribution system 100. In some embodiments, the gas storage system 200 can include one or more compressors 220 to meet storage and/or gas compression demand.

During operation, the compressor 220 can receive and compress fuel from the gas processing system 110 or any other suitable source and into one or more tanks 230a, 230b. As illustrated, the compressor 220 and the tanks 230a, 230b can be disposed on a common trailer skid 240. In some embodiments, the tanks 230a, 230b can be modular and/or interchangeable to provide a desired package, layout, and/or capacity. The capacity of the tanks 230a, 230b can be selected to provide a desired buffer, runtime, or excess capacity in view of the forecast gas supply and/or downstream demand. In some embodiments, the tanks 230a, 230b can be sized to provide between 30 minutes to 90 minutes of runtime at approximately 200,000 standard cubic feet per hour of demand. The gas storage system 200 can include any suitable number and size of tanks to meet demand.

In the depicted example, the compressed stored fuel within the tanks 230a, 230b can be deployed to the downstream devices 170 via the high-pressure distribution device 152 of the gas distribution system 150.

In some embodiments, the operation of the gas storage system 200 is controlled by a controller 210. In the depicted example, the controller 210 controls the flow of power from a power supply 190 to the compressor 220, thereby controlling the operation of the compressor 220 and the flow of compressed fuel into the tanks 230a, 230b. Optionally, the controller 210 further controls the operation of valves between the tanks 230a, 230b and the downstream devices 170. Optionally, the controller 210 may receive input or may otherwise communicate with control cube 180, which may also control operations of the gas processing and distribution system 100. In some embodiments, the controller 210 is disposed on the common trailer skid 240.

In the depicted example, the controller 210 can utilize one or more sensors and/or parameters to monitor the supply or capacity of the fuel source. In some embodiments, the controller 210 can utilize a pressure sensor or other suitable sensors to determine the capacity of the fuel source. Further, the controller 210 can utilize one or more sensors and/or parameters to determine the demand of the one or more downstream devices 170. In some embodiments, the controller 210 can utilize a flow rate sensor or other suitable sensor to determine the demand of the downstream devices 170. In some applications, the controller 210 can monitor the pressure of the tanks 230a, 230b to determine the capacity of the tanks 230a, 230b and/or the demand of the downstream devices 170.

In some applications, the controller 210 can activate the compressor 220 to compress fuel into the tanks 230a, 230b if excess fuel capacity is available and the pressure of the tanks 230a, 230b is below a pressure threshold. As discussed herein, the compressor 220 can “slipstream” excess fuel capacity from the fuel source while allowing the fuel source to meet the demand of the downstream devices 170. Further, the controller 210 can release fuel from the tanks 230a, 230b if demand from the downstream devices 170 exceeds the supply (e.g., a pressure drop in the fuel source) and tanks 230a, 230b have sufficient pressure. In some embodiments, demand from the downstream devices 170 may draw fuel from the tanks 230a, 230b, reducing pressure in the tanks 230a, 230b. In some embodiments, the gas storage system 200 can run in a “bypass” mode if the demand from the downstream device 170 is met by the fuel supply and tanks 230a, 230b have sufficient tank pressure.

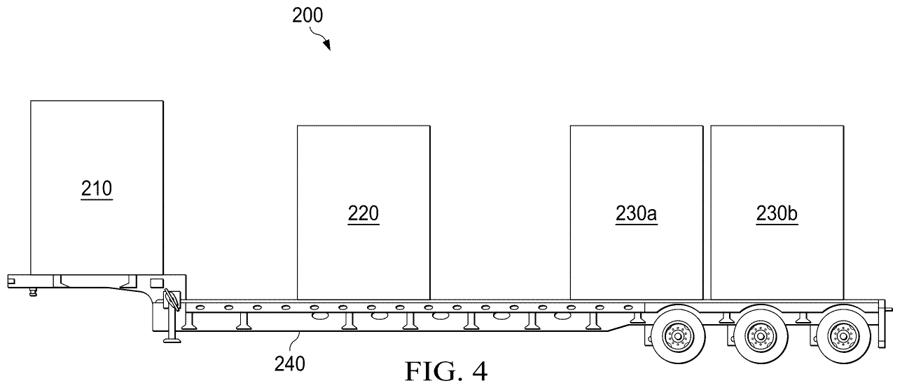

FIG. 4 is a side elevation view of the gas storage system 200 of FIGS. 2 and 3. As described herein, the components of the gas storage system 200 can be disposed on a common trailer skid 240. Advantageously, the gas storage system 200 can be easily and rapidly deployed to remote sites and placed into service. In some embodiments, the tanks 230a, 230b can be disposed adjacent to each other. As illustrated, the controller 210 and the compressor 220 can be spaced apart and disposed on the surface of the trailer skid 240. In some embodiments, the components of the gas storage system 200 can be deployed on one or more trailer skids 240. Further, in some embodiments, multiple gas storage systems 200 can be deployed on multiple trailer skids 240 or a common trailer skid 240.

It is understood that variations may be made in the foregoing without departing from the scope of the present disclosure. In several exemplary embodiments, the elements and teachings of the various illustrative exemplary embodiments may be combined in whole or in part in some or all of the illustrative exemplary embodiments. In addition, one or more of the elements and teachings of the various illustrative exemplary embodiments may be omitted, at least in part, and/or combined, at least in part, with one or more of the other elements and teachings of the various illustrative embodiments.

Any spatial references, such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several exemplary embodiments, while different steps, processes, and procedures are described as appearing as distinct acts, one or more of the steps, one or more of the processes, and/or one or more of the procedures may also be performed in different orders, simultaneously and/or sequentially. In several exemplary embodiments, the steps, processes, and/or procedures may be merged into one or more steps, processes and/or procedures.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112, paragraph 6 for any limitations of any of the claims herein, except for those in which the claim expressly uses the word “means” together with an associated function.

1. A mobile gas storage system, comprising:
a trailer skid;
one or more gas tanks; and
a compressor in fluid communication with the one or more gas tanks, wherein:
the compressor is configured to compress gas from a gas source into the one or more gas tanks;
the one or more gas tanks are configured to provide gas to a downstream device; and
at least one of the compressor or the one or more gas tanks is coupled to the trailer skid.

2. The mobile gas storage system of claim 1, wherein the compressor is configured to slipstream gas from the gas source when a gas supply of the gas source exceeds a gas demand of the downstream device.

3. The mobile gas storage system of claim 1, wherein the compressor is coupled to the trailer skid.

4. The mobile gas storage system of claim 1, further comprising a controller configured to:
activate the compressor to compress gas from the gas source into the one or more gas tanks when a gas supply of the gas source exceeds a gas demand of the downstream device; and
provide gas from the one or more gas tanks to the downstream device when a gas demand of the downstream device exceeds a gas supply of the gas source.

5. The mobile gas storage system of claim 4, further comprising a gas supply sensor in fluid communication with the gas source and operatively coupled to the controller, wherein the gas supply sensor provides a gas supply parameter to the controller.

6. The mobile gas storage system of claim 4, further comprising a gas tank sensor in fluid communication with the one or more gas tanks and operatively coupled to the controller, wherein the gas tank sensor provides a gas tank parameter to the controller.

7. The mobile gas storage system of claim 4, wherein the controller is further configured to monitor the gas demand of the downstream device.

8. The mobile gas storage system of claim 1, wherein the one or more gas tanks comprises a plurality of gas tanks.

9. The mobile gas storage system of claim 1, wherein the gas source comprises a gas processing system.

10. The mobile gas storage system of claim 9, wherein the gas processing system is configured to provide gas suitable for the downstream device.

11. The mobile gas storage system of claim 9 wherein the gas processing system comprises at least one of a slug catcher, a hydrogen sulfide regulating device, or a mobile refrigeration unit.

12. The mobile gas storage system of claim 11, wherein the gas processing system comprises the slug catcher, the hydrogen sulfide regulating device, and the mobile refrigeration unit.

13. The mobile gas storage system of claim 1, wherein the downstream device comprises a reciprocating generator.

14. The mobile gas storage system of claim 1, wherein the downstream device comprises a plurality of reciprocating generators.

15. The mobile gas storage system of claim 14, wherein the plurality of reciprocating generators are coupled to a switchgear.

16. The mobile gas storage system of claim 1, wherein the downstream device comprises a gas distribution system.

17. The mobile gas storage system of claim 16, wherein the gas distribution system comprises at least one of a high pressure distribution device, a low pressure distribution device, or a hose reel.

18. The mobile gas storage system of claim 1, wherein the one or more gas tanks are coupled to the trailer skid.

19. A method to provide gas, the method comprising:
slipstreaming gas from a gas source when a gas supply of the gas source exceeds a gas demand of a downstream device;
compressing gas from the gas source into one or more storage tanks coupled to a trailer skid; and
providing gas from the one or more storage tanks to the downstream device when the gas demand of the downstream device exceeds the gas supply of the gas source.

20. A non-transitory machine readable storage medium containing executable instructions which, when executed by a controller, cause the controller to perform a method, the method comprising:
activating a compressor to compress gas slipstreamed from a gas source into one or more gas tanks when a gas supply from the gas source exceeds a gas demand of a downstream device, wherein the compressor or the one or more gas tanks are coupled to a trailer skid; and
providing gas from the one or more gas tanks to the downstream device when the gas demand of the downstream device exceeds the gas supply of the gas source.
